(19) United States
(12) Patent Application Publication
(10) Pub. No.: US 2025/0189975 A1
(43) Pub. Date: Jun. 12, 2025

(54) POSITIONING ADJUSTING MECHANISM AND POSITIONING ADJUSTING SYSTEM

(71) Applicants: Yasufumi TAKAHASHI, Kanagawa (JP); Taku KITAHARA, Tokyo (JP); Hiroshi OKAMOTO, Kanagawa (JP); Tetsurou SASAMOTO, Kanagawa (JP)

(72) Inventors: Yasufumi TAKAHASHI, Kanagawa (JP); Taku KITAHARA, Tokyo (JP); Hiroshi OKAMOTO, Kanagawa (JP); Tetsurou SASAMOTO, Kanagawa (JP)

(21) Appl. No.: 18/843,727

(22) PCT Filed: Feb. 27, 2023
(86) PCT No.: PCT/IB2023/051795

§ 371 Date: Sep. 4, 2024

(30) Foreign Application Priority Data
Mar. 7, 2022 (JP) 2022-034668
Jan. 6, 2023 (JP) 2023-001295

(51) Int. Cl. G05D 1/43; G05D 1/661

(52) U.S. Cl. CPC G05D 1/43; G05D 1/661

(57) ABSTRACT

A positioning adjusting mechanism for a traveling device, includes: a main body; a pair of traveling bodies on respective sides of the main body and configured to be driven in contact with a surface on which the traveling device travels; a first contact member configured to come into contact with side portions of the pair of traveling bodies while the traveling device approaches a predetermined stop position; and a second contact member configured to come into contact with front portions of the pair of traveling bodies in response to the traveling device reaching the stop position.

### TECHNICAL FIELD

The present disclosure relates to a positioning adjusting mechanism and a positioning adjusting system.

### BACKGROUND ART

Recently, in various use environments and applications, autonomous mobile robots (traveling devices) have been utilized to assist work that has been performed by persons or to perform work in an environment which persons cannot handle.

For example, Patent Literature (PTL) 1 discloses, as an example of such an autonomous traveling device, a traveling device including crawler-type traveling bodies to increase the stability during traveling.

### CITATION LIST

### Patent Literature

### [PTL 1]

Japanese Unexamined Patent Application Publication No. 2021-116061

### SUMMARY OF INVENTION

### Technical Problem

The traveling device described above, however, lacks a mechanism for stopping at a target position with an increased accuracy.

### Solution to Problem

According to one embodiment of the present disclosure, a positioning adjusting mechanism for a traveling device includes a main body, a pair of traveling bodies, a first contact member, and a second contact member. The pair of traveling bodies are on respective sides of the main body and are driven in contact with a surface on which the traveling device travels. The first contact member comes into contact with side portions of the pair of traveling bodies while the traveling device approaches a predetermined stop position. The second contact member comes into contact with front portions of the pair of traveling bodies in response to the traveling device reaching the stop position.

According to another embodiment of the present disclosure, a positioning adjusting system includes the positioning adjusting mechanism and a controller that controls an operation of the traveling device. The controller causes the traveling device to move to a first set position where the traveling device is separate from the first contact member and from the second contact member, faces the second contact member, and faces in a direction in which the traveling device is to travel straight along the first contact member, and causes the traveling device to move straight to a second set position where the pair of traveling bodies of the traveling device abut on the second contact member, to position the traveling device at the stop position.

### Advantageous Effects of Invention

According to the embodiments of the present disclosure, the accuracy of positioning the traveling device increases.

### BRIEF DESCRIPTION OF DRAWINGS

A more complete appreciation of embodiments of the present disclosure and many of the attendant advantages and features thereof can be readily obtained and understood from the following detailed description with reference to the accompanying drawings.

FIG. 1 is a perspective view of a traveling device used in an embodiment.

FIG. 2 is a side view of a crawler-type traveling body illustrated in FIG. 1.

FIG. 3 is a diagram illustrating an example of a hardware configuration of the traveling device.

FIG. 4 is a diagram for describing a mechanism of a charging task in the embodiment.

FIG. 5 is a diagram illustrating a schematic configuration of a positioning adjusting system according to the embodiment.

FIG. 6 is a flowchart of the charging task.

FIG. 7 is a perspective view of a positioning adjusting mechanism according to the embodiment.

FIG. 8 is a perspective view of the traveling device that is positioned by the positioning adjusting mechanism.

FIG. 9 is a plan view illustrating a first step of an adjustment process performed by the positioning adjusting mechanism.

FIG. 10 is a side view illustrating a second step of the adjustment process performed by the positioning adjusting mechanism.

FIG. 11 is a side view illustrating a third step of the adjustment process performed by the positioning adjusting mechanism.

FIG. 12A is a plan view illustrating a first variation of the positioning adjusting mechanism.

FIG. 12B is a plan view illustrating a second variation of the positioning adjusting mechanism.

FIG. 12C is a plan view illustrating a third variation of the positioning adjusting mechanism.

FIG. 13 is a plan view illustrating a fourth variation of the positioning adjusting mechanism.

FIG. 14 is a plan view illustrating a fifth variation of the positioning adjusting mechanism.

FIG. 15 is a diagram illustrating an application example of the positioning adjusting system according to the embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure will be described below with reference to the attached drawings. In order to facilitate understanding of the description, the same components are denoted by the same reference signs in the drawings as much as possible, and redundant description is omitted.

A positioning adjusting system 100 according to an embodiment positions a traveling device 1 at a stop position. In the embodiment, the traveling device 1 including crawler-type traveling bodies 10a and 10b will be described as an example of a traveling device. In the embodiment, a charging task involving positioning of the traveling device 1 at a chargeable position C of a charging device 110 will be described as an example of a task involving positioning of the traveling device 1.

### <Configuration of Traveling Device>

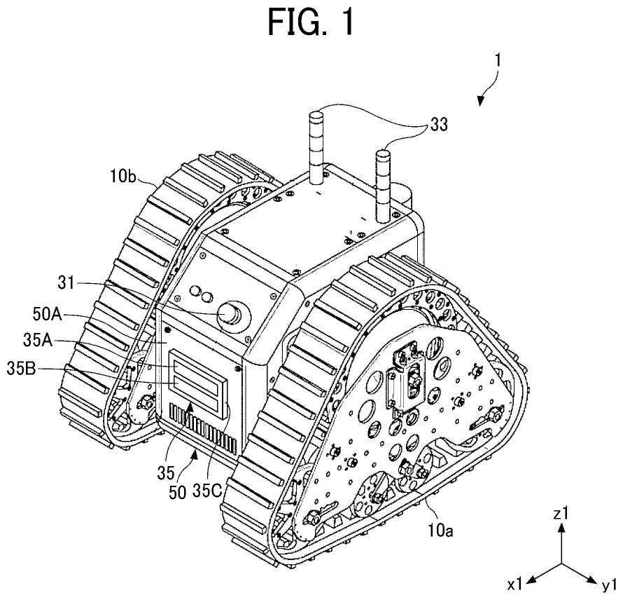

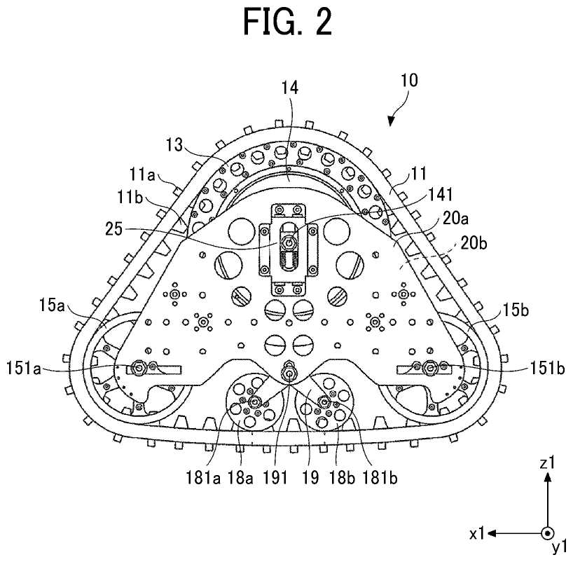

A configuration of the traveling device 1 including the crawler-type traveling bodies 10a and 10b will be described with reference to FIGS. 1 to 3. FIG. 1 is a perspective view of the traveling device 1 used in the embodiment. FIG. 2 is a side view of a crawler-type traveling body 10 illustrated in FIG. 1. The pair of crawler-type traveling bodies 10a and 10b have the same configuration, and thus are collectively referred to as the crawler-type traveling body 10 in FIG. 2.

In description of FIGS. 1 and 2, an x1 direction, a y1 direction, and a z1 direction are perpendicular to each other. The x1 direction and the y1 direction are horizontal directions, and the z1 direction is a vertical direction. The x1 direction is a front-rear direction of the traveling device 1. The y1 direction is a left-right direction of the traveling device 1. In the description below, for convenience of explanation, a positive side in the z1 direction may be referred to as an upper side, and a negative side in the z1 direction may be referred to as a lower side.

As illustrated in FIG. 1, the traveling device 1 includes a main body 50 at a center in the y1 direction, and a pair of traveling bodies on respective sides of the main body 50 in the y1 direction, to be driven in contact with a surface on which the traveling device 1 travels. The pair of traveling bodies are the crawler-type traveling bodies 10a and 10b. The traveling device 1 provides a speed difference between the pair of crawler-type traveling bodies 10a and 10b to change a traveling direction.

As illustrated in FIGS. 1 and 2, to travel in a stable attitude, the traveling device 1 uses the triangle crawler-type traveling bodies 10. Each of the crawler-type traveling bodies 10 includes a drive wheel having an in-wheel motor built in and two rotating wheels. As described above, the traveling device 1 including the crawler-type traveling bodies 10 has high traveling performance and can stably travel on uneven rough ground. On the other hand, it is more difficult to finely adjust the position of the traveling device 1 including the crawler-type traveling bodies 10 than the traveling device 1 including wheels. Thus, it is difficult to move the traveling device 1 including the crawler-type traveling bodies 10 to a target position with a high accuracy.

The traveling device 1 including the crawler-type traveling bodies 10 is prone to stop in an attitude inclined in the left-right and up-down directions. Thus, the traveling device 1 including the crawler-type traveling bodies 10 has an issue of an unstable stopping attitude.

The crawler-type traveling bodies 10 desirably implements highly accurate positioning within an error of about ±several tens of millimeters with respect to the target position or keeps the attitude within an error of about ±several degrees when the crawler-type traveling bodies 10 stop for charging, coupling/separating an object to be conveyed, or the like.

The configuration of each part of the traveling device 1 will be further described. The crawler-type traveling bodies 10a and 10b are units serving as moving means of the traveling device 1. Each of the crawler-type traveling bodies 10a and 10b is a crawler-type traveling body that uses a metal or rubber belt. The crawler-type traveling body has a larger ground contact area than a traveling body that travels with tires such as an automobile and thus implements stable traveling even in an environment of rough ground conditions, for example. The traveling body that travels with tires requires a space to make a turn, whereas the traveling device including the crawler-type traveling bodies can perform a so-called spin turn and thus can smoothly turn even in a limited space.

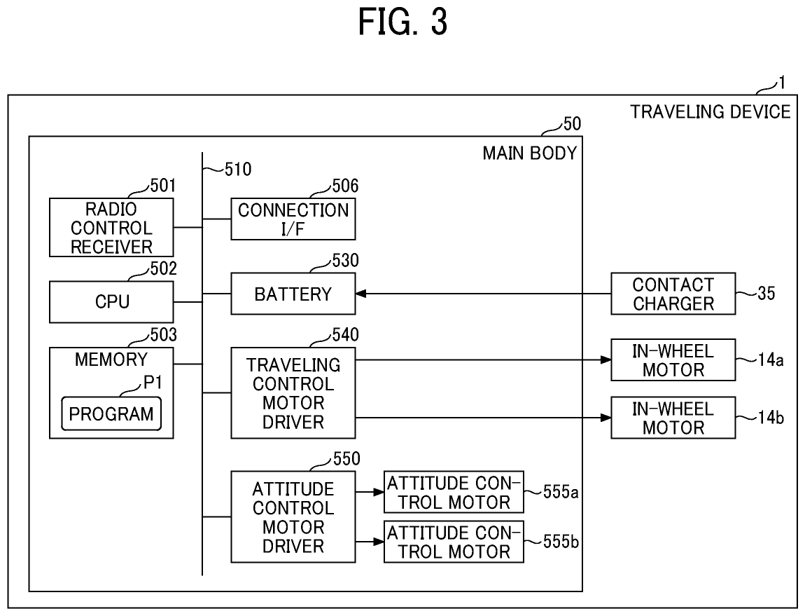

The main body 50 is a support body that supports the crawler-type traveling bodies 10a and 10b to allow the crawler-type traveling bodies 10a and 10b to travel. The main body 50 also includes a controller that performs control for driving the traveling device 1. The main body 50 includes a battery 530 (described later in FIG. 3) that supplies electric power for driving the crawler-type traveling bodies 10a and 10b.

As illustrated in FIG. 1, the main body 50 of the traveling device 1 includes an emergency stop button 31, a state indicator lamp 33, and a contact charger 35. The emergency stop button 31 is an operation means, which is pressed by a person around the traveling device 1 to stop the traveling device 1 that is traveling.

The state indicator lamp 33 is a notification means, which notifies a person located nearby of a state of the traveling device 1. For example, in response to a change in the state of the traveling device 1 such as a decrease in a remaining battery level, the state indicator lamp 33 is turned on to notifies a person located nearby of the change in the state of the traveling device 1. The state indicator lamp 33 is turned on in response to a sign of the occurrence of an abnormality, for example, in response to detection of the presence of an obstacle that is to hinder the traveling device 1 from traveling. FIG. 1 illustrates an example in which the traveling device 1 includes the two state indicator lamps 33. However, the number of state indicator lamps 33 may be one or three or more. In addition to the state indicator lamp 33, the notification means may be any notification member that notifies a person located nearby of the state of the traveling device 1, such as a warning sound or the like output from a speaker.

The contact charger 35 is a component that supplies electric power from the charging device 110 to the battery 530 in the main body 50 in response to a contact with the charging device 110 in the charging task. In the embodiment, the main body 50 has a substantially rectangular parallelepiped shape, and has, at a foremost portion thereof, a front face 50A whose normal direction is the x1 direction. The contact charger 35 is installed at the front face 50A. The contact charger 35 includes two metal contact faces 35A and 35B provided at the front face of a rectangular frame body 35C made of a resin, for example. The two contact faces 35A and 35B have substantially the same shape that is a substantially rectangular shape whose a longitudinal side or long side is in the y1 direction, and are arranged in parallel with each other.

As illustrated in FIG. 2, the crawler-type traveling body 10 has a triangular shape formed by a drive wheel 13 and two rotating wheels 15a and 15b. For example, when the size of the traveling body in the front-rear direction is restricted, the crawler-type traveling body 10 having the triangular shape can increase the ground contact area within the limited size in the front-rear direction and thus can improve the stability of traveling. On the other hand, in the case of a so-called tank-type crawler whose upper portion (adjacent to the drive wheel) is longer than a lower portion (adjacent to the rotating wheels), the ground contact area decreases and the stability of traveling decreases when the size in the front-rear direction is restricted. As described above, the crawler-type traveling body 10 is effective in improving the traveling performance of the traveling device 1 that is relatively small.

The crawler-type traveling body 10 includes a crawler belt 11, the drive wheel 13, an in-wheel motor 14, the rotating wheels 15a and 15b, idler wheels 18a and 18b, a link 19, side plates 20a and 20b, and a tensioner 25.

The crawler belt 11 is also called a crawler, and is made of a metal or rubber. The crawler belt 11 is stretched around the drive wheel 13 and the rotating wheels 15a and 15b. The crawler belt 11 moves in a rotational direction of the drive wheel 13 to cause the rotating wheels 15a and 15b to rotate together, and thus rotates the crawler-type traveling body 10. The crawler belt 11 has a plurality of protrusions 11a and a plurality of protrusions 11b on respective surfaces thereof. The protrusions 11a are provided on an outer surface of the crawler belt 11 to allow the traveling body 10 to stably travel over a small obstacle such as a stone on a road surface, for example. The protrusions 11b are provided on an inner surface of the crawler belt 11 so that the crawler belt 11 does not come off from the drive wheel 13 or the rotating wheel 15a or 15b, for example.

The drive wheel 13 transmits a driving force for rotating the crawler-type traveling body 10 to the crawler belt 11. In the crawler-type traveling body 10, the in-wheel motor 14 transmits the driving force (rotational force) to the drive wheel 13, and the drive wheel 13 transmits the driving force (rotational force) to the rotating wheels 15a and 15b through the crawler belt 11.

The in-wheel motor 14 is built in the drive wheel 13 and transmits the rotational force to the drive wheel 13. The in-wheel motor 14 is rotationally driven about a motor shaft 141 serving as a drive shaft. The rotation shaft (the motor shaft 141) of the in-wheel motor 14 serves as the rotation shaft (drive shaft) of the drive wheel 13, so that the drive wheel 13 rotates with the rotational force of the in-wheel motor 14. The rotational force of the in-wheel motor 14 is transmitted to the crawler belt 11 as a driving force. Specifically, the in-wheel motor 14 causes the drive wheel 13 to rotate in a positive direction, which causes the traveling device 1 to move forward, or causes the drive wheel 13 to rotate in a negative direction, which causes the traveling device 1 to move backward.

The in-wheel motor 14 built in the drive wheel 13 simplifies the structure of the crawler-type traveling body 10. For example, the in-wheel motor 14 built in the drive wheel 13 omits the use of a component such as a drive chain or a gear, thus reducing a risk such as a failure caused by such a component. In addition, the in-wheel motor 14 built in the drive wheel 13 enables a driving force to be generated in the vicinity of the outer periphery of the crawler-type traveling body 10, thus increasing the torque.

The rotating wheels 15a and 15b are attached to the crawler-type traveling body 10 to be rotatable. The driving force (rotational force) transmitted from the drive wheel 13 through the crawler belt 11 rotates the rotating wheels 15a and 15b about rotating wheel shafts 151a and 151b as rotation shafts, respectively.

The drive wheel 13 and the rotating wheels 15a and 15b form a triangle when viewed from the side. The crawler belt 11 is stretched around the drive wheel 13 and the rotating wheels 15a and 15b and a range of the crawler belt 11 between the rotating wheels 15a and 15b comes into contact with the ground. That is, the drive wheel 13 having the in-wheel motor 14 built therein does not come into contact with the road surface. Even when the crawler-type traveling body 10 travels in a puddle for example, the in-wheel motor 14 does not sink in the water. Thus, the in-wheel motor 14 does not need a special waterproof mechanism.

The diameter of the drive wheel 13 is different from the diameter of the rotating wheels 15a and 15b. The layout of traveling bodies is desirably designed in consideration of factors such as desired size limitation and desired traveling performance. In general, the torque per unit width of a motor in the thickness (width) of the motor tends to decrease as the diameter of the motor decreases. Thus, the drive wheel having the in-wheel motor built therein desirably has a diameter that is equal to or larger than the diameter of the motor that implements the desired torque performance. Accordingly, the layout that satisfies the desired traveling performance and the size limitation of the traveling device 1 or the crawler-type traveling body 10, the crawler-type traveling body 10 is designed such that the diameter of the drive wheel 13 disposed in an upper portion of the crawler-type traveling body 10 is larger than the diameter of the rotating wheels 15a and 15b. Note that an increased diameter of the rotating wheel under the size limitation reduces the ground contact area, leading to a reduced traveling stability. Accordingly, adopting the rotating wheels 15a and 15b having a smaller diameter than the drive wheel 13 has a merit.

The idler wheels 18a and 18b are auxiliary wheels disposed between the two rotating wheels 15a and 15b and driven to rotate by the crawler belt 11. The idler wheels 18a and 18b rotate about idler wheel shafts 181a and 181b as rotation shafts, respectively. The link 19 is a support member that supports the idler wheels 18a and 18b.

The side plate 20a supports the drive wheel 13, the rotating wheels 15a and 15b, and the idler wheels 18a and 18b in the crawler-type traveling body 10. The side plate 20a is installed at a side face of the crawler-type traveling body 10 on the positive side in the y1 direction. A side plate 20b having the same shape as the side plate 20a is installed on a side opposite to the side plate 20a, that is, at a side surface of the crawler-type traveling body 10 on the negative side in the y1 direction. The crawler-type traveling body 10 has a double-sided structure in which the two side plates 20a and 20b are used to support the drive wheel 13, the rotating wheels 15a and 15b, and so on. The side plates 20a and 20b use the motor shaft 141 to support the drive wheel 13. The side plates 20a and 20b use the rotating wheel shafts 151a and 151b to support the rotating wheels 15a and 15b, respectively. The side plates 20a and 20b support the idler wheels 18a and 18b through a link shaft 191 of the link 19 that supports the idler wheels 18a and 18b.

The tensioner 25 includes an elastic member such as a spring and is coupled to the motor shaft 141 that is the rotation shaft of the in-wheel motor 14 and the drive wheel 13. The tensioner 25 is disposed so that the drive wheel 13 is pressed against the inner side of the crawler belt 11 to apply tension to the crawler belt 11. The tensioner 25 functions to adjust tension applied to the crawler belt 11 from the drive wheel 13 when the crawler-type traveling body 10 travels. For example, the tensioner 25 functions to maintain reference tension substantially constant when the crawler-type traveling body 10 travels, with reference to the tension at the time when the crawler-type traveling body 10 is stationary. Adjustment of the sag of the crawler belt 11 by the tensioner 25 enables transmission of a normal driving force through the crawler belt 11 to be maintained in the crawler-type traveling body 10. Application of tension to the crawler belt 11 by the tensioner 25 prevents the crawler belt 11 from coming off from the wheels in the crawler-type traveling body 10.

As illustrated in FIGS. 1 and 2, the crawler-type traveling body 10 has a substantially symmetrical structure with respect to a center of the drive wheel 13 in a front-rear traveling direction. Specifically, the crawler-type traveling body 10 has a substantially symmetrical structure with respect to a line passing through the motor shaft 141 of the in-wheel motor 14 that is perpendicular to a line coupling the rotating wheel shafts 151a and 151b of the two rotating wheels 15a and 15b, in a side view that is viewed from the y1 axis direction as illustrated in FIGS. 1 and 2.

For example, a traveling device that travels in a narrow space such as a corridor of an office frequently performs forward and backward movements and a spin turn. In such a case, if a shape of the crawler belt or the arrangement of the drive wheel, the rotating wheels, the tensioner, or the like is asymmetric in the front-rear direction, driving characteristics of the traveling device may change when moving forward and when moving backward or may fail to turn about the center when making a spin turn. In contrast, the crawler-type traveling body 10 has the layout (structure) that is substantially symmetrical in the front-rear direction. This leads to an increased traveling stability or simplified control when the traveling device 1 travels. Since the crawler-type traveling body 10 can be attached without caution for the right and left sides of the traveling device 1, the number of components can be reduced.

FIG. 3 is a diagram illustrating an example of a hardware configuration of the traveling device 1. As illustrated in FIG. 1, the traveling device 1 includes the main body 50 that controls a process or operation of the traveling device 1. The main body 50 includes a radio control receiver 501, a central processing unit (CPU) 502, a memory 503, a communication interface (I/F) 506, the battery 530, a traveling control motor driver 540, an attitude control motor driver 550, and attitude control motors 555a and 555b. In addition, the radio control receiver 501, the CPU 502, the memory 503, the communication I/F 506, the battery 530, the traveling control motor driver 540, and the attitude control motor driver 550 are connected to one another via a system bus 510. The system bus 510 is an address bus, a data bus, or the like for electrically connecting the above components to one another and transmits an address signal, a data signal, various control signals, and the like.

The radio control receiver 501 receives operation instruction signals transmitted from a transmitter such as a personal computer (PC) used by an operator of the traveling device 1.

The CPU 502 performs overall control of the traveling device 1. The CPU 502 is an arithmetic device that reads a program P1 and various kinds of data for use in the operation of the traveling device 1 from the memory 503 and performs a process to implement functions of the traveling device 1.

The memory 503 stores the program P1 to be executed by the CPU 502 and the various kinds of data for use in the operation of the traveling device 1. The program P1 is preinstalled in the memory 503.

Alternatively, the program P1 may be provided after being stored on a recording medium readable by the CPU 502 (computer), such as a compact disc read-only memory (CD-ROM), a flexible disk (FD), a compact disc recordable (CD-R), or a digital versatile disc (DVD), as a file of an installable or executable format. The program P1 may be provided after being stored in a computer connected to a network such as the Internet and is downloaded to the traveling device 1 via the network. The program P1 may be provided or distributed via a network such as the Internet. If the program P1 is provided from outside, the CPU 502 reads the program P1 via the communication I/F 506. Rather than the CPU 502 causing the traveling device 1 to operate in accordance with the program P1, the traveling device 1 may be caused to operate by hardware such as a dedicated application specific integrated circuit (ASIC) having the same calculation functions and control functions as those implemented by the program P1.

The communication I/F 506 connects and communicates with other devices or apparatuses via a communication network. The communication I/F 506 is, for example, a communication interface for a wired or wireless local area network (LAN), for example. The communication I/F 506 may include a communication interface for 3rd generation (3G), Long Term Evolution (LTE)), 4th generation (4G)), 5th generation (5G), Wireless Fidelity (Wi-Fi)®, Worldwide Interoperability for Microwave Access (WiMAX), Zigbee®, millimeter-wave wireless communication, or the like. The traveling device 1 may include a communication circuit for performing short-range wireless communication such as Near Field Communication (NFC) or Bluetooth®.

The battery 530 is a power supply unit that supplies electric power for use in the process or operation of the traveling device 1. For example, the battery 530 supplies electric power to in-wheel motors 14a and 14b and the attitude control motors 555a and 555b. The battery 530 is electrically connected to the contact charger 35, and is supplied with the electric power and charged from the charging device 110 through the contact charger 35 in the charging task.

The traveling control motor driver 540 supplies motor drive signals to the in-wheel motors 14a and 14b to drive the in-wheel motors 14a and 14b.

The in-wheel motors 14a and 14b are disposed inside a drive wheel 13a of the crawler-type traveling body 10a and a drive wheel 13b of the crawler-type traveling body 10b, respectively, and transmit the rotational force to the drive wheels 13a and 13b, respectively. The in-wheel motors 14a and 14b cause the drive wheels 13a and 13b to rotate in a positive direction, causing the traveling device 1 to move forward and cause the drive wheels 13a and 13b to rotate in a negative direction, causing the traveling device 1 to move backward, respectively. The in-wheel motors 14a and 14b rotate one drive wheel 13a (or 13b) in the positive direction or the negative direction and stop the other drive wheel 13b (or 13a) to cause the traveling device 1 to make a pivot turn. In addition, the in-wheel motors 14a and 14b rotate one drive wheel 13a (or 13b) in the positive direction and rotate the other drive wheel 13b (or 13a) in the negative direction to cause the traveling device 1 to make a spin turn.

The attitude control motor driver 550 supplies motor drive control signals to the attitude control motors 555a and 555b to drive the attitude control motors 555a and 555b. The attitude control motors 555a and 555b receive the attitude control signals from the attitude control motor driver 550 and change the height of the link 19 up and down to adjust the heights of the idler wheels 18a and 18b, for example. The attitude control motors 555a and 555b control the attitude of the main body 50 so that the traveling device 1 does not fall down, for example.

The traveling device 1 is not limited to the above-described device that travels in accordance with operation instructions received by the radio control receiver 501 and may travel using a technique such as autonomous traveling or line tracing. Alternatively, the traveling device 1 may receive, via the communication I/F 506, operation instruction signals transmitted via a communication network and travel based on a remote operation performed by a user at a remote place. In addition to the manual remote operation performed by an operator (user), the traveling device 1 may automatically perform operations such as traveling and various tasks in accordance with an upper-layer system such as a server. In this case, the traveling device 1 can receive operation instruction signals from the upper-layer system via the radio control receiver 501 or the communication I/F 506.

The traveling device 1 illustrated in FIGS. 1 to 3 have dimensions, for example, a length in the front-rear direction, a width in the left-right direction, and a height of about 1 meter.

The traveling device serving as a target of the positioning adjusting system 100 according to the embodiment is not limited to the traveling device 1 including the crawler-type traveling bodies 10 illustrated in FIGS. 1 to 3. That is, the target of the positioning adjusting system 100 according to the embodiment is not limited to the crawler-type traveling bodies 10 in which the tensioner 25 is disposed above the rotating shaft 141 of the in-wheel motor 14. This is because fine adjustment of positioning is similarly difficult in crawler-type traveling devices having other configurations.

Autonomous traveling devices desirably have a high positioning accuracy with respect to a target position to cope with work in a poor road surface environment or a limited space. There is room for improvement in such positioning accuracy of the autonomous traveling devices of the related art. In particular, in a structure in which the traveling direction is changed by providing a speed difference between a pair of traveling bodies, such as the crawler-type traveling bodies disclosed in PTL 1, for example, this issue is significant because fine position adjustment is difficult.

### <Overview of Charging Task>

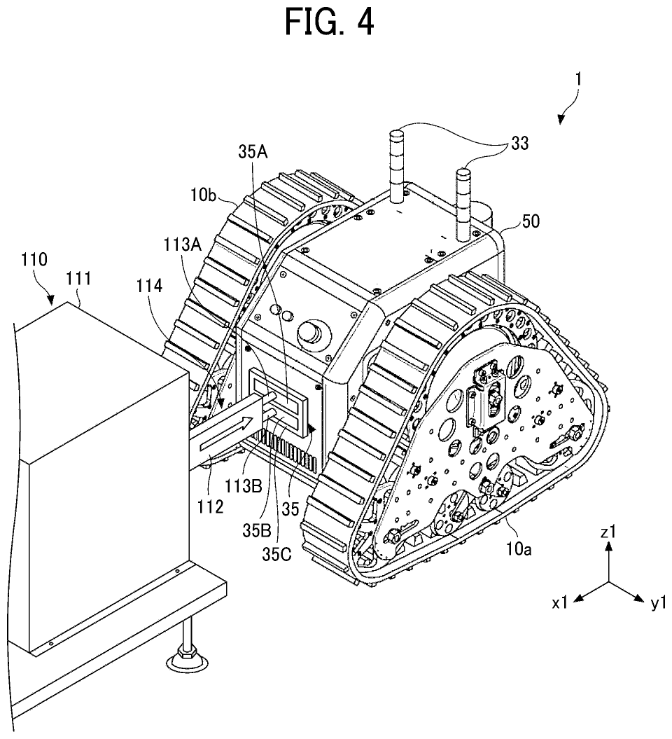

As an example of a configuration for positioning the traveling device 1, a configuration of a charging task involving positioning of the traveling device 1 at the chargeable position C of the charging device 110 will be described. FIG. 4 is a diagram for describing a mechanism of the charging task in the embodiment.

For example, the contact charger 35 includes the resin frame body 35C in which the two metal contact faces 35A and 35B are disposed. The two contact faces 35A and 35B have a substantially the same shape that is a horizontally long rectangular shape and are arranged one above the other.

The charging device 110 includes a charging device main body 111 and a terminal portion 114. The terminal portion 114 includes a base portion 112 extendable from the charging device main body 111, and two contact terminals 113A and 113B at the tip of the base portion 112. An elastic element such as a spring is coupled to a base of each of the contact terminals 113A and 113B. The contact terminals 113A and 113B retract into the base portion 112 when hitting the contact charger 35.

The charging device 110 detects, for example, such a motion of the contact terminals 113A and 113B to determine whether the terminal portion 114 is in contact with the contact charger 35 of the traveling device 1. The two contact terminals 113A and 113B are arranged one above the other in the vertical direction, similarly to the two contact faces 35A and 35B of the traveling device 1. The arrangement direction of the contact terminals 113A and 113B and of the contact faces 35A and 35B may be any direction in which each of the pairs is arranged in parallel with each other such that corresponding ones of the pairs can contact, that is, may be any direction such as the left-right direction (widthwise direction or y1 direction) other than the vertical direction (z1 direction).

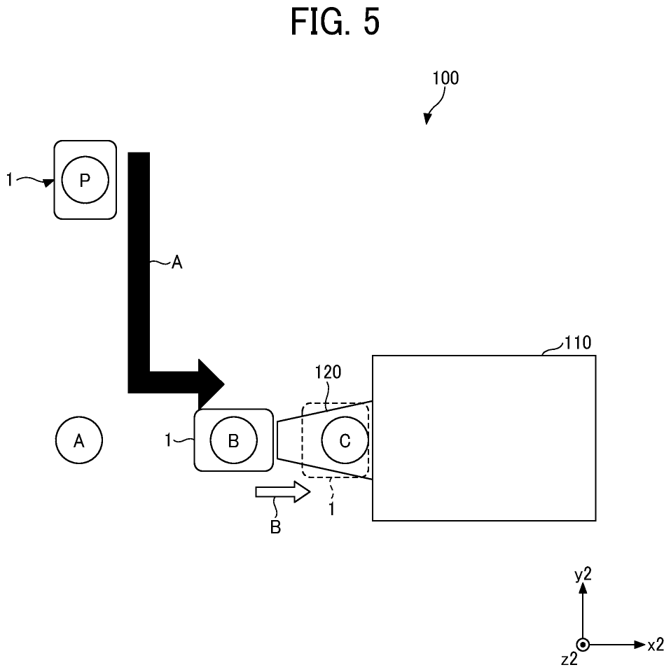

In the charging task, as illustrated in FIG. 4, the traveling device 1 is first caused to move to a stop position (corresponding to the chargeable position C illustrated in FIG. 5 and the like) at a predetermined distance from the charging device 110. At this stop position, the contact charger 35 of the traveling device 1 faces the terminal portion 114 of the charging device 110. Next, as indicated by an arrow in FIG. 4, the base portion 112 of the terminal portion 114 of the charging device 110 extends toward the traveling device 1, and the contact terminals 113A and 113B at the tip of the base portion 112 come into contact with the contact charger 35 of the traveling device 1. Then, the battery 530 of the traveling device 1 is charged by the charging device 110 through the terminal portion 114 and the contact charger 35.

As described above, since the contact faces 35A and 35B of the contact charger 35 have a substantially rectangular shape with a longer side in the y1 direction. Thus, even if a positional shift occurs between the contact faces 35A and 35B and the respective contact terminals 113A and 113B in the horizontal direction, the contact terminals 113A and 113B are easily brought into contact with the contact faces 35A and 35B as long as the amount of the positional shift is within the range of the longer side of the contact faces 35A and 35B. The contact faces 35A and 35B of the contact charger 35 have, for example, a dimension of about 60 mm in the horizontal direction, and thus handle a positional shift of about ±30 mm in the horizontal direction. That is, the contact terminals 113A and 113B of the terminal portion 114 is successfully brought into contact with the respective contact faces 35A and 35B. The two contact faces 35A and 35B have a dimension of about 30 mm in the vertical direction, and thus handle a positional shift to some extent. However, since the two contact faces 35A and 35B are arranged on the same plane, an issue may occur in which one of the two contact terminals 113A and 113B is not brought into contact if the attitude of the traveling device 1 largely shifts from the attitude of the charging device 110 due to forward inclination or backward inclination.

Note that the structure of the charging task illustrated in FIG. 4 is an example, and the charging task is not limited to the contact charging type illustrated in FIG. 4 and may use any other method such as non-contact charging. In any case, the traveling device 1 is to be brought close to the charging device 110, for example, to a position where the traveling device 1 is chargeable.

As described above, the accuracy desired for the charging task is about ±several tens of millimeters in the horizontal direction with respect to the traveling direction of the traveling device 1. At this time, a horizontal and vertical inclination of the traveling device 1 with respect to the charging device 110 may cause an issue in charging. For this reason, the inclination of the traveling device 1 is to be kept within about ±several degrees.

When the traveling device 1 is operated as a transport robot, the traveling device 1 desirably autonomously couples and separates a transport-target object from the viewpoint of manpower saving. In this case, the same levels of stop position accuracy and attitude stabilization as those in the charging task are desired as described above.

### <Positioning Adjusting System>

The positioning adjusting system 100 according to the embodiment will be described with reference to FIGS. 5 to 11. FIG. 5 is a diagram illustrating a schematic configuration of the positioning adjusting system 100 according to the embodiment. In FIG. 5, as an example of a configuration for positioning the traveling device 1, the configuration of the charging task involving positioning of the traveling device 1 at the chargeable position C of the charging device 110 will be described.

In description of FIG. 5 and subsequent figures, an x2 direction, a y2 direction, and a z2 direction are perpendicular to each other. The x2 direction and the y2 direction are horizontal directions, and the z2 direction is a vertical direction. The x2 direction is a direction in which the charging device 110 and a positioning adjusting mechanism 120 are arranged, is a direction in which points A, B, and C are arranged, and is a depth direction of the positioning adjusting mechanism 120. The y2 direction is a widthwise direction of the positioning adjusting mechanism 120. In the description below, for convenience of explanation, a positive side in the z2 direction may be referred to as an upper side, and a negative side in the z2 direction may be referred to as a lower side.

As illustrated in FIG. 5, the positioning adjusting system 100 includes the traveling device 1 and the positioning adjusting mechanism 120. The positioning adjusting system 100 includes the controller that controls the operation of the traveling device 1. In the embodiment, elements such as the CPU 502 and/or the traveling control motor driver 540 in the main body 50 of the traveling device 1 function as the controller. That is, the controller is built in the main body 50 of the traveling device 1.

The positioning adjusting mechanism 120 is an element for guiding the traveling device 1 to a stop position that is predetermined and stopping the traveling device 1 at the stop position while adjusting the position and the attitude. In the embodiment, the “stop position that is predetermined” or “predetermined stop position” is the chargeable position C where the traveling device 1 is chargeable by the charging device 110. The chargeable position C is a position where the contact charger 35 of the traveling device 1 comes into contact with the terminal portion 114 of the charging device 110 illustrated in FIG. 4 and is a position on the negative side of the charging device 110 in the x2 direction. The positioning adjusting mechanism 120 is installed adjacently to the charging device 110 on the negative side in the x2 direction such that the traveling device 1 faces the charging device 110 at the chargeable position C.

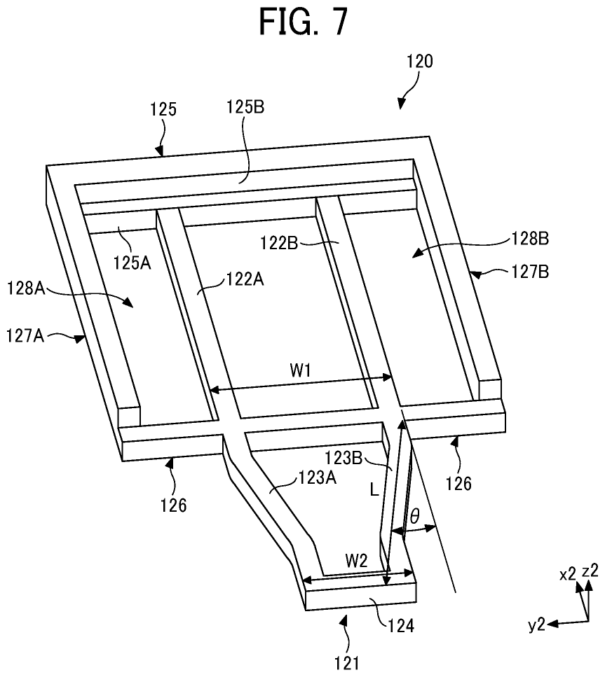

The positioning adjusting mechanism 120 is a member made of a plurality of quadrangular pillars linked together on a plane, for example. Details of the configuration of the positioning adjusting mechanism 120 will be described later with reference to FIG. 7 and the like.

A place that is a separate from the charging device 110 is defined as an initial position (upper left position in FIG. 5) P. In the charging task illustrated in FIG. 5, the traveling device 1 moves from the initial position P to the chargeable position C (second set position) where the traveling device 1 is chargeable by the charging device 110. The positioning adjusting mechanism 120 according to the embodiment is disposed at the chargeable position C.

The point B (first set position) is set at a position further on the negative side in the x2 direction relative to a negative-side end portion of the positioning adjusting mechanism 120 in the x2 direction side. The point B is, for example, a position separated from the negative-side end portion of the positioning adjusting mechanism 120 in the x2 direction by about 1 m. The point A is set at a position on the negative side relative to the point B in the x2 direction. The point A is, for example, a position separated from the position of the negative-side end portion of the positioning adjusting mechanism 120 in the x2 direction by about 5 m. That is, the point A, the point B, and the chargeable position C are arranged in a straight line in the x2 direction.

In the example illustrated in FIG. 5, the initial position P of the traveling device 1 is set on the positive side relative to the point A in the y2 direction. However, the arrangement of the initial position P is not limited to this position. The initial position P may be any position where the traveling device 1 is at least guidable to the point A.

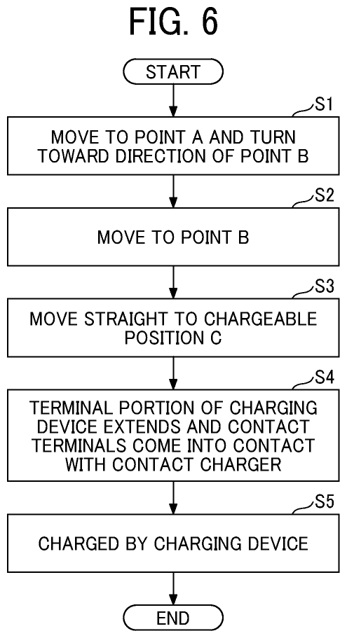

FIG. 6 is a flowchart of the charging task.

In step S1, the controller of the traveling device 1 causes the traveling device 1 to move from the initial position P to the point A, and to turn at the point A so that the front face 50A of the traveling device 1 faces the positive side in the x2 direction. That is, the traveling device 1 is positioned at the point A so that the direction of the point B and the chargeable position C is the forward traveling direction of the traveling device 1.

In step S2, the controller of the traveling device 1 causes the traveling device 1 to move from the point A to the point B.

It is preferable that the moving operation (indicated by an arrow A in FIG. 5) of the traveling device 1 from the initial position P to the point B (first set position), that is, the processing in steps S1 and S2, is performed, for example, autonomously using the global positioning system (GPS). In this case, the controller of the traveling device 1 detects the position of the traveling device 1 using a GPS signal, and performs control to move the traveling device 1 from the initial position P to the point B through the point A. This enables, even when the initial position P is set to any position, the traveling device 1 to eventually move to the point B (first set position) with an accuracy of an allowable range. This thus increases the degree of freedom in setting the initial position P.

Note that the control for moving the traveling device 1 from the initial position P to the point B in steps S1 and S2 may be any control that causes the traveling device 1 to move to the point B at least with the accuracy of the allowable range. For example, a configuration using information other than the GPS signal, such as a self-position detection technique using a light detection and ranging (LiDAR) sensor, may be used. The “accuracy of the allowable range” is, for example, a range in which the position is adjustable by the positioning adjusting mechanism 120 according to the embodiment.

In the example illustrated in FIG. 5, the distance from the point A to the point B is about 4 m. It is experimentally known that the movement over the distance of about 4 m from the point A to the point B based on the above movement control enables the position and the angle in the left-right direction to be controlled to a level at which the traveling device 1 successfully enters the positioning adjusting mechanism 120.

In step S3, the controller of the traveling device 1 causes the traveling device 1 to move from the point B to the chargeable position C. Unlike steps S1 and S2, the movement control in step S3 does not use the GPS signal or the like and the traveling device 1 autonomously travels straight. For example, when the traveling device 1 reaches the point B in step S2, the controller can communicate with the charging device 110 by wireless communication or the like. This configuration allows the controller of the traveling device 1 to recognize that the traveling device 1 has reached the first set position (point B), in response to a trigger that is receipt of some kind of information from the charging device 110, for example. After this recognition, the controller causes the traveling device 1 to travel forward by a predetermined distance to move to the chargeable position C. The distance over which the traveling device 1 travels forward in the step S3 depends on the dimension of the positioning adjusting mechanism 120 in the x2 direction and is, for example, about 50 cm to 1 m.

In step S3, the position and the attitude of the traveling device 1 are adjusted by the positioning adjusting mechanism 120 according to the embodiment before the traveling device 1 reaches the chargeable position C, and the traveling device 1 then reaches the target stop position. It is preferable to move the traveling device 1 at a low speed when the traveling device 1 travels straight from the point B to the chargeable position C in step S3. The degree by which the speed is decreased at this time is settable such that a speed is lower than the speed to travel to the point B, for example. This suppresses forward and backward swinging due to acceleration and deceleration. It is more preferable that the speed at this time is constant. This further suppresses forward and backward swinging due to acceleration and deceleration.

How the positioning adjusting mechanism 120 adjusts the position and the attitude of the traveling device 1 in step S3 will be described with reference to FIGS. 7 to 11.

FIG. 7 is a perspective view of the positioning adjusting mechanism 120 according to the embodiment. As illustrated in FIG. 7, the positioning adjusting mechanism 120 includes a first guide member 121 (first contact member), a second guide member 125 (second contact member), a third guide member 126 (third contact member), and walls 127A and 127B.

The first guide member 121 comes into contact with side portions of the pair of crawler-type traveling bodies 10a and 10b, particularly the side portions of the crawler belts 11 in the embodiment, while the traveling device 1 is approaching the predetermined stop position (chargeable position C). The first guide member 121 abuts on the side portions of the pair of crawler-type traveling bodies 10a and 10b to adjust the position and the attitude of the traveling device 1 in the left-right direction. In the embodiment, the first guide member 121 is disposed to abut on the (inner) side portions, of the pair of crawler-type traveling bodies 10a and 10b, adjacent to the main body 50.

When the traveling device 1 reaches the stop position, the second guide member 125 comes into contact with front portions (adjacent to the rotating wheels 15a) of the pair of crawler-type traveling bodies 10a and 10b, particularly front portions of the crawler belts 11 in the embodiment. The second guide member 125 hits the front portions of the pair of crawler-type traveling bodies 10a and 10b to adjust the position and the attitude of the traveling device 1 in the front-rear direction. In the embodiment, the second guide member 125 extends in the direction (y2 direction) in which the pair of crawler-type traveling bodies 10a and 10b of the traveling device 1 are arranged.

The first guide member 121 includes a pair of straight portions 122A and 122B and a pair of inclined portions 123A and 123B. The pair of straight portions 122A and 122B extend in parallel with each other in a direction (x2 direction) orthogonal to the extending direction of the second guide member 125, and base end portions of the pair of straight portions 122A and 122B on the positive side in the x2 direction are coupled to the second guide member 125. The pair of inclined portions 123A and 123B are coupled to tip end portions of the pair of straight portions 122A and 122B on the negative side in the x2 direction, respectively, and extend in a direction at a predetermined angle θ with respect to the extending direction of the straight portions 122A and 122B, respectively. The pair of inclined portions 123A and 123B are formed such that the space therebetween narrows as the distance from the coupling portions where the pair of inclined portions 123A and 123B are coupled to the respective straight portions 122A and 122B increases, that is, toward the negative side in the x2 direction. In other words, the inclined portions 123A and 123B are inclined at the predetermined angle θ in the x2 and y2 planes with respect to the extending direction of the straight portions 122A and 122B. The inclined portions 123A and 123B and the straight portions 122A and 122B are respectively inclined with respect to each other. In the embodiment, the inclined portions 123A and 123B extend substantially linearly.

The first guide member 121 has a front end portion 124 that couples the tip end portions of the pair of inclined portions 123A and 123B together and extends in the arrangement direction (y2 direction) of the pair of crawler-type traveling bodies 10a and 10b of the traveling device 1.

That is, a portion of the first guide member 121 on the negative side in the x2 direction has a substantially trapezoidal shape formed by the pair of inclined portions 123A and 123B and the front end portion 124. A widths W1 in the y2 direction between the base end portions of the pair of inclined portions 123A and 123B on the positive side in the x2 direction is larger than a width W2 between the tip end portions of the pair of inclined portions 123A and 123B on the negative side in the x2 direction, that is, the length of the front end portion 124.

When the traveling device 1 reaches the stop position (chargeable position C), the third guide member 126 abuts on the rear portions (adjacent to the rotating wheels 15b) of the pair of crawler-type traveling bodies 10a and 10b, particularly the rear portions of the crawler belts 11 in the embodiment to adjust the position and the attitude of the traveling device 1 in the front-rear direction. In the embodiment, the third guide member 126 extends in the same direction (y2 direction) as the second guide member 125, and is disposed at a position passing through the coupling portion of the straight portions 122A and 122B and the inclined portions 123A and 123B of the first guide member 121.

The pair of walls 127A and 127B are disposed on outer sides of the pair of crawler-type traveling bodies 10a and 10b in the left-right direction, respectively, when the traveling device 1 is at the stop position (the chargeable position C). In the embodiment, end portions of the pair of walls 127A and 127B on the positive side in the x2 direction are coupled to respective ends of the second guide member 125, and end portions of the pair of walls 127A and 127B on the negative side in the x2 direction are coupled to the respective ends of the third guide member 126.

The heights of the first guide member 121 and the third guide member 126 are substantially the same. These heights (dimensions) are preferably set to be at least larger than the thicknesses of the crawler belts 11 of the crawler-type traveling bodies 10, and are about 30 mm, for example. The heights (dimensions) of the pair of walls 127A and 127B are set to be larger than (for example, about twice) the heights of the first guide member 121 and the third guide member 126, and are about 60 mm, for example.

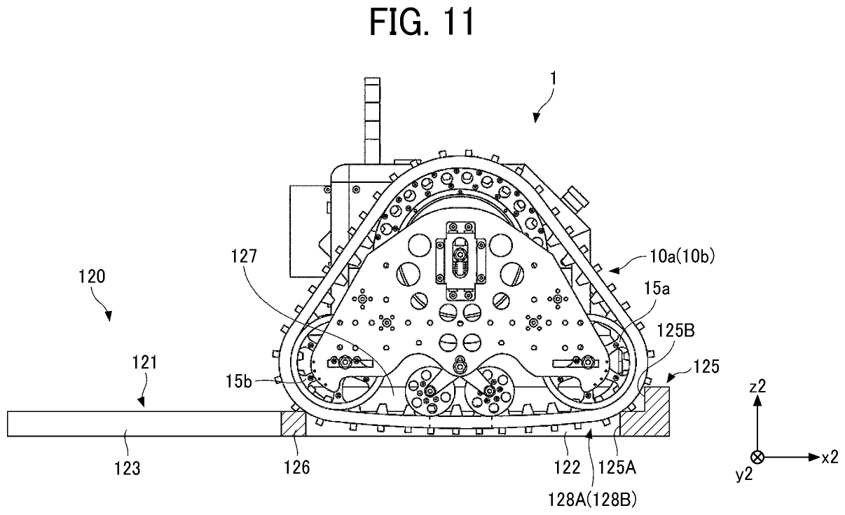

The second guide member 125 has a step shape toward the front portions of the pair of crawler-type traveling bodies 10. That is, the second guide member 125 has a step shape in which a higher step 125B is located on the positive side in the x2 direction. The second guide member 125 has two steps in the example of FIG. 7 but may have three or more steps. The step shape of the second guide member 125 is preferably disposed to correspond to the curved shape of the crawler belts 11 along the rotating wheels 15a at the front portions of the crawler-type traveling bodies 10 in the side view illustrated in FIG. 11 and the like such that corner portions of the steps 125A and 125B on the negative side in the x2 direction come into contact with the crawler-type traveling bodies 10 almost simultaneously when the traveling device 1 approaches.

When the second guide member 125 has the two-step shape illustrated in FIG. 7, it is preferable that the height (dimension) of the lower step 125A on the negative side in the x2 direction is substantially the same as the heights of the first guide member 121 and the third guide member 126 and the height of the higher step 125B on the positive side in the x2 direction is substantially the same as the heights of the pair of walls 127A and 127B.

This enables the first guide member 121 to be more reliably brought into contact with the side portions of the crawler belts 11 of the crawler-type traveling bodies 10, enables the second guide member 125 to be more reliably brought into contact with the front portions of the crawler belts 11 of the crawler-type traveling bodies 10, and enables the third guide member 126 to be more reliably brought into contact with the rear portions of the crawler belts 11 of the crawler-type traveling bodies 10. As a result, the first guide member 121, the second guide member 125, and the third guide member 126 can more reliably guide the position and the attitude of the crawler-type traveling body 10.

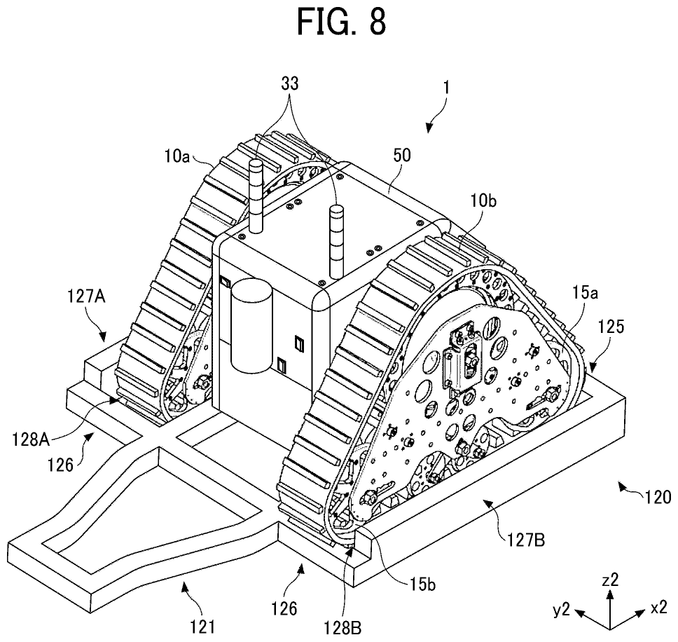

FIG. 8 is a perspective view of the traveling device 1 that is positioned by the positioning adjusting mechanism 120. As illustrated in FIGS. 7 and 8, in the positioning adjusting mechanism 120, the straight portion 122A of the first guide member 121, the second guide member 125, the third guide member 126, and the wall 127A form a substantially rectangular recess 128A into which the crawler-type traveling body 10a is fitted. Likewise, the straight portion 122B of the first guide member 121, the second guide member 125, the third guide member 126, and the wall 127B form a substantially rectangular recess 128B into which the crawler-type traveling body 10b is fitted.

As illustrated in FIG. 8, when the traveling device 1 eventually reaches the chargeable position C, the pair of crawler-type traveling bodies 10a and 10b of the traveling device 1 are respectively fitted into and positioned in the recesses 128A and 128B of the positioning adjusting mechanism 120.

At this time, the front sides of the crawler belts 11 of the traveling device 1 hit the second guide member 125. At the same time, the rear sides of the crawler belts 11 are also in contact with the third guide member 126. Thus, the inclination of the entire traveling device 1 in the vertical direction is regulated, and the angle is stabilized. At this time, the pair of walls 127A and 127B higher than the other guide members are disposed on the outer sides of the crawler belts 11, so that the traveling device 1 does not protrude from the recesses 128A and 128B of the positioning adjusting mechanism 120. The pair of walls 127A and 127B also have a function of returning the traveling device 1 inclined in the left-right direction at the time of guiding.

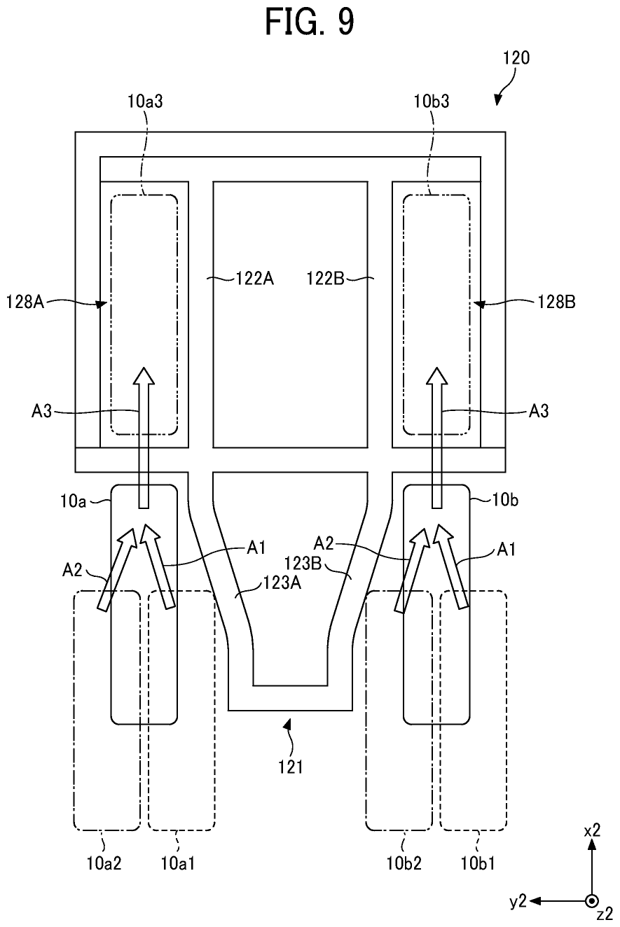

The recesses 128A and 128B are disposed such that when the traveling device 1 is at the chargeable position C, the outer edges of the lower portions of the crawler-type traveling bodies 10a and 10b of the traveling device 1 fits inside the recesses 128A and 128B in plan view (see two-dot-chain lines 10a3 and 10b3 in FIG. 9). To form such recesses 128A and 128B, the dimension of the second guide member 125 in the longitudinal direction (y2 direction) is set to be larger than the dimension of the traveling device 1 in the widthwise direction. The coupling positions of the pair of straight portions 122A and 122B of the first guide member 121 with the second guide member 125 are set such that the distance W1 between the outer edges of the pair of straight portions 122A and 122B in the y2 direction is smaller than the dimension of the main body 50 of the traveling device 1 in the widthwise direction. The length of the pair of straight portions 122A and 122B in the longitudinal direction (x2 direction) are set to be substantially equal to the lengths of the lower portions of the crawler-type traveling bodies 10a and 10b of the traveling device 1 in the front-rear direction.

FIG. 9 is a plan view illustrating a first step of an adjustment process performed by the positioning adjusting mechanism 120. As illustrated in FIG. 9, when the traveling device 1 enters the positioning adjusting mechanism 120, the trapezoidal portion at the tip of the first guide member 121, that is, the portion formed by the pair of inclined portions 123A and 123B and the front end portion 124 is located between the crawler-type traveling bodies 10a and 10b of the traveling device 1. At this time, if the position of the traveling device 1 in the left-right direction is shifted in the y2 direction from the chargeable position C, this trapezoidal portion comes into contact with side surfaces of the inner sides (adjacent to the main body 50) of the lower portions of the traveling bodies 10a and 10b and thus applies a force in the left-right direction to the crawler-type traveling bodies 10, so that the position of the traveling device 1 is successfully adjusted in the left-right direction when the traveling device 1 moves forward. This configuration enables adjustment of the position in the left-right direction by guiding the crawler-type traveling bodies 10 without adding a component to the traveling device 1.

For example, when the traveling device 1 is shifted to the right (toward the negative side in the y2 direction) as indicated by dash lines in FIG. 9, a left crawler-type traveling body 10al comes into contact with the left inclined portion 123A of the first guide member 121. The traveling device 1 keeps moving forward in the x2 direction in this state, so that the crawler-type traveling body 10al presses the inclined portion 123A and receives a reaction force from the inclined portion 123A. As a result, the traveling device 1 moves to a left front position as indicated by an arrow A1, and is adjusted to a correct position in the left-right direction as indicated by the crawler-type traveling bodies 10a and 10b indicated by solid lines. Thereafter, the crawler-type traveling bodies move straight in the x2 direction as illustrated by an arrow A3 while being guided from the inner side in the widthwise direction by the straight portions 122A and 122B, and eventually the crawler-type traveling bodies 10a3 and 10b3 respectively fit into the recesses 128A and 128B and stop as illustrated by the two-dot-chain lines in FIG. 9.

Likewise, when the traveling device 1 is shifted to the left (toward the positive direction in the y2 direction) as indicated by one-dot-chain lines in FIG. 9, a right crawler-type traveling body 10b2 comes into contact with the right inclined portion 123B of the first guide member 121. The traveling device 1 keeps moving forward in the x2 direction in this state, so that the crawler-type traveling body 10b2 presses the inclined portion 123B and receives a reaction force from the inclined portion 123B. As a result, the traveling device 1 moves to a right front position as indicated by an arrow A2, and is adjusted to a correct position in the left-right direction as indicated by the crawler-type traveling bodies 10a and 10b indicated by the solid lines. Thereafter, the crawler-type traveling bodies move straight in the x2 direction as illustrated by the arrow A3, and eventually the crawler-type traveling bodies 10a3 and 10b3 respectively fit into the recesses 128A and 128B and stop as illustrated by the two-dot-chain lines.

In the trapezoidal portion of the first guide member 121, the W1 in which the traveling device 1 eventually enters is preferably set such that a slight margin (for example, about 20 to 30 mm) is added to a dimension of a space between the inner edges of the crawler-type traveling bodies 10. The W2 at the tip of the trapezoidal portion is desirably as small as possible to increase the entry margin. On the other hand, the entire size of the mechanism reduces as the length L of the inclined portions 123A and 123B of the first guide member 121 decreases. The angle θ at this time is determined by the widths W1 and W2 and the length L. However, if the angle θ becomes equal to or larger than a certain value, guiding may fail. In this experiment, it has been confirmed that guiding is successful if the angle θ is smaller than about 16 degrees. Thus, the angle θ is set within this range. At the time of actual evaluation, the position of the traveling device 1 is adjusted using guides that are set such that W1=360 mm, W2=160 mm, L=300 mm, and θ=15.7 degrees. In this case, (W1−W2)/2=100 holds. Thus, the traveling device 1 is successfully guided if the position of the traveling device 1 is shifted from the target position within a range of 100 mm in the left-right direction. That is, the range in which the traveling device 1 is successfully guided by the positioning adjusting mechanism 120 can fall within the error range of the GPS.

When the above-described condition for the angle θ is satisfied, the function of adjusting the position in the left-right direction improves as the length L increases. Ideally, the inclined portions 123A and 123B preferably has a triangular shape. However, if the length L is too long, the dimension of the first guide member 121 in the front-rear direction increases and consequently the size of the positioning adjusting mechanism 120 increases. Therefore, in the embodiment, to implement the adjustment function and suppress the increase in size, the front end of the first guide member 121 has a trapezoidal shape having the width W2 to guarantee the angle θ and reduce the size.

In the charging task, the charging device 110 is expectedly installed outdoors. In this case, a roof is conceivably provided above the charging device 110 and the chargeable position C at which the traveling device 1 stops when the traveling device 1 is connected to the charging device 110, in order to prevent rain or the like from entering the devices.

If the size of the positioning adjusting mechanism 120 increases due to, for example, an increase in the dimension L of the inclined portions 123A and 123B of the first guide member 121 as described above, the size of the roof provided above the charging device 110 is to be increased. Therefore, it is desirable to reduce the size of the positioning adjusting mechanism 120 as much as possible and to sufficiently exhibit the guide function. The structure of the positioning adjusting mechanism 120 according to the embodiment can guarantee the guide function and the size reduction of the mechanism since the front portion of the first guide member 121 has a trapezoidal shape as described above.

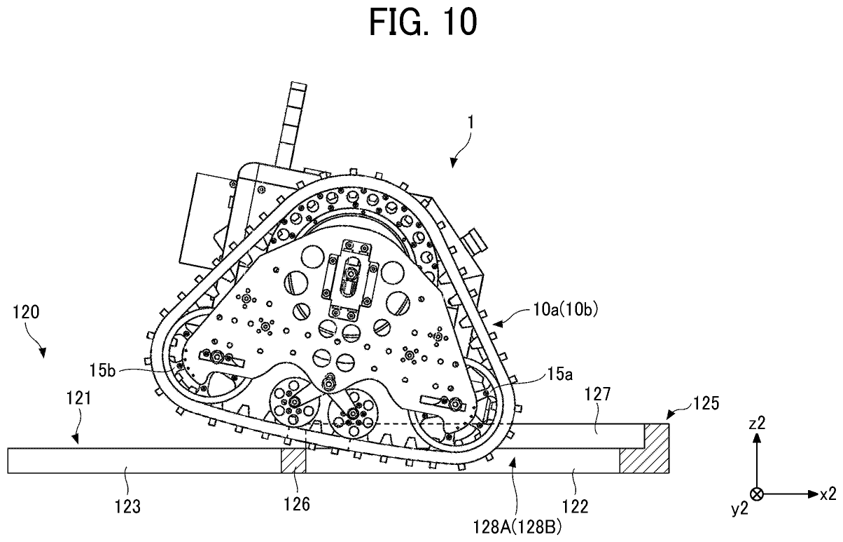

FIG. 10 is a side view illustrating a second step of the adjustment process performed by the positioning adjusting mechanism 120. FIG. 10 illustrates a part of the positioning adjusting mechanism 120 as a cross-section. As illustrated in FIG. 10, after the position of the traveling device 1 is adjusted in the left-right direction by the first guide member 121, the crawler-type traveling bodies 10a and 10b travel over the third guide member 126 and enter the recesses 128A and 128B.

FIG. 11 is a side view illustrating a third step of the adjustment process performed by the positioning adjusting mechanism 120. FIG. 11 also illustrates a part of the positioning adjusting mechanism 120 as a cross-section. As illustrated in FIG. 11, the traveling device 1 keeps traveling forward at a constant speed, and the front portions of the crawler-type traveling bodies 10a and 10b eventually hit the corner portions of the respective steps 125A and 125B of the second guide member 125, so that the traveling device 1 stops at the target position. At this time, the rear portions of the crawler-type traveling bodies 10a and 10b are also in contact with the corner portions of the third guide member 126 on the positive side in the x2 direction. As a result, the crawler-type traveling bodies 10a and 10b are fitted into the recesses 128A and 128B of the positioning adjusting mechanism 120, respectively, and are positioned in the front-rear direction and the left-right direction. The second guide member 125 and the third guide member 126 come into contact with the front and rear portions of the traveling bodies 10, so that the attitude of the traveling device 1 is also oriented in the horizontal direction.

Referring back to FIG. 6, in step S4, the base portion 112 of the terminal portion 114 of the charging device 110 extends toward the traveling device 1, and the contact terminals 113A and 113B come into contact with the contact faces 35A and 35B of the contact charger 35 of the traveling device 1, respectively. That is, the state described with reference to FIG. 4 is achieved.

In step S5, the charging device 110 performs charging. For example, when both of the contact terminals 113A and 113B of the terminal portion 114 respectively hit the contact faces 35A and 35B of the contact charger 35 to receive a reaction force and the charging device 110 detects the reaction force. At this time, the charging device 110 determines that coupling with the contact charger 35 has been completed and starts charging control.

As described above, in the positioning adjusting system 100 according to the embodiment, the controller of the traveling device 1 first causes the traveling device 1 to move to the first set position (point B) where the traveling device 1 is separate from the first guide member 121 and from the second guide member 125, faces the second guide member, and is oriented in a direction in which the traveling device 1 is to travel straight along the first guide member (steps S1 and S2). Secondly, the controller of the traveling device 1 causes the traveling device 1 to move straight to the second set position (chargeable position C) where the pair of crawler-type traveling bodies 10a and 10b of the traveling device 1 abut on the second guide member 125 (step S3). Thus, the traveling device 1 is positioned at the predetermined stop position. In steps S1 and S2, the controller detects the position of the traveling device 1 using the GPS signal, and performs control to move the traveling device 1 to the first set position.

This configuration allows, after moving the traveling device 1 to a rough position based on the GPS (with an accuracy of ±several tens of centimeters to one meter), the traveling device 1 to move straight and to be positioned simply and accurately with the positioning adjusting mechanism 120.

The positioning adjusting mechanism 120 according to the present embodiment includes the first guide member 121 that abuts on the side portions of the pair of traveling bodies 10a and 10b while the traveling device 1 approaches the predetermined stop position (chargeable position C) to adjust the position and the attitude of the traveling device 1 in the left-right direction, and the second guide member 125 that hits the front portions of the pair of traveling bodies 10a and 10b when the traveling device 1 reaches the stopping position to adjust the position and the attitude of the traveling device 1 in the front-rear direction.

With this configuration, with the operation of causing the traveling device 1 to enter the positioning adjusting mechanism 120, the first guide member 121 first adjusts the position and the attitude of the traveling device 1 in the left-right direction with respect to the chargeable position C, and the second guide member 125 then adjusts the position and the attitude of the traveling device 1 in the front-rear direction. That is, the adjustment of the position and the attitude of the traveling device 1 in the front-rear direction and the left-right direction can be easily and highly accurately performed merely by the operation of causing the traveling device 1 to enter the positioning adjusting mechanism 120. As a result, the positioning adjusting mechanism 120 according to the embodiment can increase the accuracy of positioning the traveling device 1.

In the positioning adjusting mechanism 120 according to the embodiment, the first guide member 121 is disposed to abut on the side portions of the pair of traveling bodies 10a and 10b that are (on the inner sides) adjacent to the main body 50. This configuration can reduce the dimension in the widthwise direction of the first guide member 121a, and consequently make the positioning adjusting mechanism 120 compact.

In the positioning adjusting mechanism 120 according to the embodiment, the second guide member 125 extends in the direction (y2 direction) in which the pair of traveling bodies 10a and 10b of the traveling device 1 are arranged. The first guide member 121 includes the pair of straight portions 122A and 122B that extend in a direction (x2 direction) orthogonal to the direction in which the second guide member 125 extends and that have the base end portions coupled to the second guide member 125, and the pair of inclined portions 123A and 123B that respectively couple to the tip portions of the pair of straight portions 122A and 122B and extend in a direction at the predetermined angle θ with respect to the direction in which the straight portions 122A and 122B extend. The space between the pair of inclined portions 123A and 123B narrows as the distance from the coupling portions where the pair of inclined portions 123A and 123B are coupled to the respective straight portions 122A and 122B increases.

With this configuration, when the traveling device 1 enters the positioning adjusting mechanism 120, the traveling device 1 is first caused to travel forward along the pair of inclined portions 123A and 123B to perform position adjustment in the left-right direction such that the positions of the traveling bodies 10a and 10b of the traveling device 1 match the positions of the straight portions 122A and 122B. Then, the traveling device 1 is caused to move forward along the pair of straight portions 122A and 122B to perform attitude adjustment so that the traveling device 1 is not inclined in the left-right direction. Thus, the position and the attitude of the traveling device 1 in the left-right direction with respect to the chargeable position C can be adjusted more reliably.

In the positioning adjusting mechanism 120 according to the embodiment, the first guide member 121 includes the front end portion 124 that couples the tip end portions of the pair of inclined portions 123A and 123B to each other and extends in the direction (y2 direction) in which the pair of traveling bodies 10a and 10b are arranged. This configuration can reduce the dimension of the pair of inclined portions 123A and 123B in the front-rear direction and thus can make the positioning adjusting mechanism 120 smaller.

The positioning adjusting mechanism 120 according to the embodiment includes the third guide member 126 that abuts on the rear portions of the pair of traveling bodies 10a and 10b when the traveling device 1 reaches the stop position (chargeable position C) to adjust the position and the attitude of the traveling device 1 in the front-rear direction. With this configuration, in addition to the positioning of the front positions of the traveling bodies 10a and 10b by the second guide member 125, the positioning of the rear positions of the traveling bodies 10a and 10b by the third guide member 126 can be performed at the same time. Therefore, the position and the attitude of the traveling device 1 can be adjusted with higher accuracy.

When the pair of traveling bodies of the traveling device 1 is of a crawler-type, fine position adjustment is difficult not only in the left-right direction but also in the front-rear direction. Since the crawler has a function of traveling over an obstacle, the attitude tends to be inclined forward or backward. Thus, the attitude tends to change. When the traveling device 1 stops at the charging position in the forward or backward inclined attitude, the terminal portion 114 of the charging device 110 may fail to come into contact with the chargeable range of the contact charger 35 of the traveling device 1. Thus, how to determine the attitude of the traveling device 1 at the stop position is also a factor.

In this embodiment, since the front portions of the traveling bodies 10 are positioned by the second guide member 125 and the rear portions of the traveling bodies 10 are positioned by the third guide member 126, so that the attitude of the traveling device 1 can be easily set to be horizontal.

In the case of the crawler-type traveling device 1, the lower central surface of the crawler belt 11 is in contact with the ground in the side view of FIG. 2. However, this corresponds to the case when the traveling device 1 is stationary. When the traveling device 1 accelerates, the front end of the traveling device 1 rises and the traveling device 1 is slightly inclined backward. In contrast, when the traveling device 1 decelerates or stops, an inertial force is applied to the front portion of the traveling device 1 and the traveling device 1 is slightly inclined forward. Therefore, when the traveling device 1 accelerates to approach the predetermined stop position or decelerates the traveling bodies to stop, the traveling device 1 stops in a forward or backward inclined state. In the embodiment, when the traveling device 1 travels straight from the point B to the chargeable position C in step S3, the traveling device 1 is caused to move at a constant speed and hits the second guide member 125 to stop. This can suppress the forward or backward inclined attitude when the traveling device 1 reaches the chargeable position C and thus can stabilize the attitude at the time of stopping. Consequently, not only the position but also the attitude can be appropriately adjusted. “Positioning the attitude” with the positioning adjusting mechanism according to the embodiment means adjusting the attitude to be a stopping attitude as illustrated in the side view of FIG. 2, for example.

The positioning adjusting mechanism 120 according to the embodiment includes the walls 127A and 127B located on the outer sides of the pair of traveling bodies 10a and 10b in the left-right direction when the traveling device 1 is at the stop position (the chargeable position C). This configuration can suppress protrusion of the traveling device 1 to outside the guide range in the left-right direction when the traveling device 1 reaches the stop position.

As described above, the positioning adjusting system 100 using the positioning adjusting mechanism 120 according to the embodiment can simply and accurately position the traveling device 1 at the predetermined stop position in a desired position, a desired direction, and a desired attitude. When the traveling device subjected to positioning is the crawler-type traveling device 1 including the pair of crawler-type traveling bodies 10a and 10b, the fine position adjustment is difficult and the change in attitude due to acceleration and deceleration is large as described above. However, the embodiment markedly exhibits the advantage described above and thus particularly effective.

### <Variations of Positioning Adjusting Mechanism>

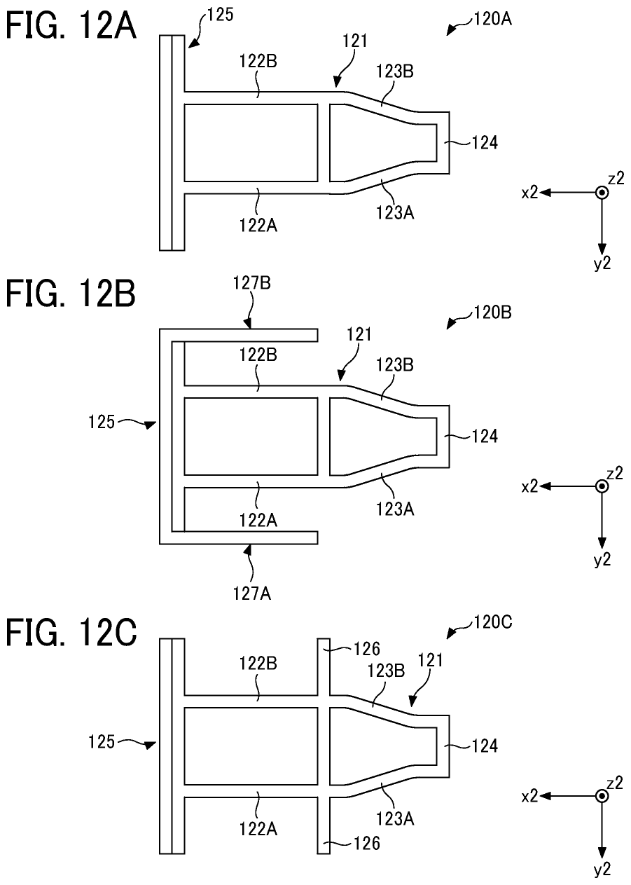

Variations of the positioning adjusting mechanism 120 according to the above-described embodiment will be described with reference to FIGS. 12A to 14. FIGS. 12A, 12B, and 12C are plan views illustrating a first variation 120A, a second variation 120B, and a third variation 120C of the positioning adjusting mechanism 120.

As in the first variation 120A illustrated in FIG. 12A, the positioning adjusting mechanism 120 may include the first guide member 121 and the second guide member 125 alone. That is, the third guide member 126 and the pair of walls 127A and 127B may be omitted from the configuration according to the above-described embodiment.

As in the second variation 120B illustrated in FIG. 12B, the positioning adjusting mechanism 120 may include the first guide member 121, the second guide member 125, and the pair of walls 127A and 127B. That is, the third guide member 126 may be omitted from the configuration according to the above-described embodiment.

As in the third variation 120C illustrated in FIG. 12C, the positioning adjusting mechanism 120 may include the first guide member 121, the second guide member 125, and the third guide member 126. That is, the pair of walls 127A and 127B may be omitted from the configuration according to the above-described embodiment.

In each of the variations 120A, 120B, and 120C respectively illustrated in FIGS. 12A, 12B, and 12C, the first guide member 121 performs the adjustment in the left-right direction and the second guide member 125 performs the adjustment in the front-rear direction as in the above-described embodiment. Thus, the same advantages as those of the positioning adjusting mechanism 120 according to the above-described embodiment can be achieved.

When the third guide member 126 is omitted as in the first variation 120A and the second variation 120B, it is preferable that the height of the second guide member 125 is larger than the height in the above-described embodiment. This enables the traveling device 1 to stop at the predetermined stop position more reliably in the appropriate position and attitude even with the configuration in which the rear portions of the crawler-type traveling bodies 10 do not come into contact with the guide member at the time of stopping. In this case, the traveling device 1 can be stopped at the appropriate position in the appropriate attitude by making the moving speed of the traveling device 1 from the point B to the chargeable position C smaller than the moving speed in the above-described embodiment.

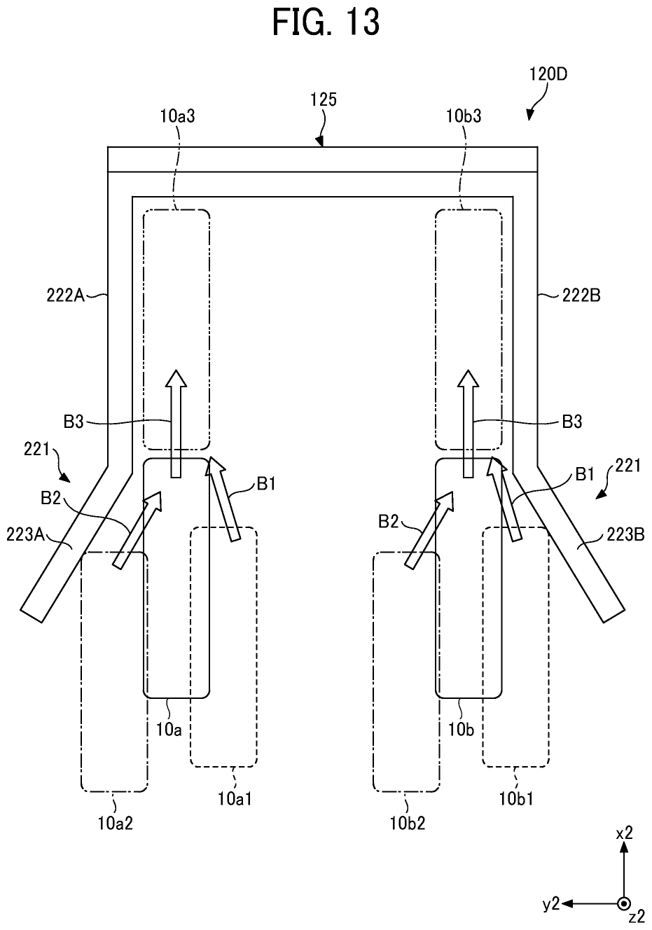

FIG. 13 is a plan view illustrating a fourth variation 120D of the positioning adjusting mechanism 120. As in the fourth variation 120D illustrated in FIG. 13, a first guide member 221 may be disposed on the outer sides of the crawler-type traveling bodies 10 in the left-right direction.

In this configuration, the first guide member 221 includes a pair of straight portions 222A and 222B and a pair of inclined portions 223A and 223B. The base end portions of the pair of straight portions 222A and 222B are coupled to the respective ends of the second guide member 125. The pair of inclined portions 223A and 223B are respectively coupled to the tip portions of the pair of straight portions 222A and 222B. The space between the pair of inclined portions 223A and 223B widens as the distance from the coupling portions where the pair of inclined portions 223A and 223B are coupled to the respective straight portions 222A and 222B increases, that is, toward the negative side in the x2 direction.

As illustrated in FIG. 13, when the traveling device 1 enters the positioning adjusting mechanism 120D, the crawler-type traveling bodies 10a and 10b of the traveling device 1 is located between the pair of inclined portions 223A and 223B of the first guide member 221. At this time, if the position of the traveling device 1 in the left-right direction is shifted in the y2 direction from the chargeable position C, the inclined portions 223A and 223B come into contact with side faces of the inner sides (opposite to the main body 50) of the lower portions of the traveling bodies 10a and 10b and thus applies a force in the lateral direction to the crawler-type traveling bodies 10, so that the position of the traveling device 1 is successfully adjusted in the left-right direction when the traveling device 1 moves forward. This configuration enables adjustment of the position in the left-right direction by guiding the crawler-type traveling bodies 10 without adding a component to the traveling device 1.

For example, when the traveling device 1 is shifted to the right (toward the negative side in the y2 direction) as indicated by dash lines in FIG. 13, a right crawler-type traveling body 10b1 comes into contact with the right inclined portion 223B of the first guide member 221. The traveling device 1 keeps moving forward in the x2 direction in this state, so that the crawler-type traveling body 10b1 presses the inclined portion 223B and receives a reaction force from the inclined portion 223B. As a result, the traveling device 1 moves to a right front position as indicated by an arrow B1, and is adjusted to a correct position in the left-right direction as indicated by the crawler-type traveling bodies 10a and 10b indicated by the solid lines. Thereafter, the crawler-type traveling bodies move straight in the x2 direction as illustrated by an arrow B3 while being guided from the outer side in the widthwise direction by the straight portions 222A and 222B, and eventually the crawler-type traveling bodies 10a3 and 10b3 hit the second guide member 125 and stop as illustrated by two-dot-chain lines in FIG. 13.

Likewise, when the traveling device 1 is shifted to the left (toward the positive direction in the y2 direction) as indicated by one-dot-chain lines in FIG. 13, a left crawler-type traveling body 10a2 comes into contact with the left inclined portion 223A of the first guide member 221. The traveling device 1 keeps moving forward in the x2 direction in this state, so that the crawler-type traveling body 10a2 presses the inclined portion 223A and receives a reaction force from the inclined portion 223A. As a result, the traveling device 1 moves to a left front position as indicated by an arrow B2, and is adjusted to a correct position in the left-right direction as indicated by the crawler-type traveling bodies 10a and 10b indicated by the solid lines. Thereafter, the crawler-type traveling bodies move straight in the x2 direction as illustrated by the arrow B3 while being guided from the outer side in the widthwise direction by the straight portions 222A and 222B, and eventually the crawler-type traveling bodies 10a3 and 10b3 hit the second guide member 125 and stop as illustrated by the two-dot-chain lines in FIG. 13.

In the fourth variations 120D illustrated in FIG. 13, the first guide member 221 performs the adjustment in the left-right direction and the second guide member 125 performs the adjustment in the front-rear direction as in the above-described embodiment. Thus, the same advantages as those of the positioning adjusting mechanism 120 according to the above-described embodiment can be achieved. The width of the space between the tip end portions of the pair of inclined portions 223A and 223B is set larger than the width of the space between the pair of straight portions 222A and 222B, that is, the width of the traveling device 1. Thus, when the traveling device 1 enters the positioning adjusting mechanism 120D, the pair of inclined portions 223A and 223B can adjust the position of the traveling device 1 even if the position in the left-right direction is shifted more than the error of the GPS (about ±100 mm), and the effective range of the position adjustment in the left-right direction can be set wider than in the above-described embodiment.

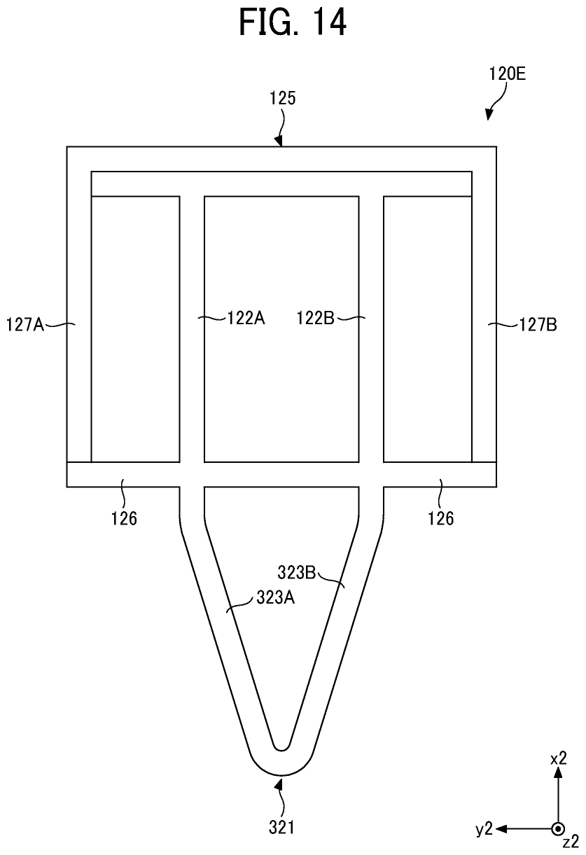

FIG. 14 is a plan view illustrating a fifth variation 120E of the positioning adjusting mechanism 120. As in the fifth variation 120E illustrated in FIG. 14, a tip end portion of a first guide member 321 may have a triangular shape that further extends toward the negative side in the x2 direction side rather than the trapezoidal shape in the above-described embodiment.

In this configuration, the first guide member 321 includes the pair of straight portions 122A and 122B and a pair of inclined portions 323A and 323B. The pair of inclined portions 323A and 323B are respectively coupled to the tip portions of the pair of straight portions 122A and 122B. The space between the pair of inclined portions 323A and 323B narrows as the distance from the coupling portions where the pair of inclined portions 323A and 323B are coupled to the respective straight portions 122A and 122B increases, that is, toward the negative side in the x2 direction and are coupled together at the tip end portion on the negative side in the x2 direction. That is, a portion on the negative side in the x2 direction of the first guide member 321 has a substantially triangular shape formed by the pair of inclined portions 323A and 323B.

The inclination angle of the pair of inclined portions 323A and 323B with respect to the extending direction of the straight portions 122A and 122B is preferably substantially equal to the angle θ of the inclined portions 123A and 123B in the above-described embodiment. Accordingly, as compared with the above-described embodiment, the length of the pair of inclined portions 323A and 323B increases, and the length from the coupling portions with the pair of straight portions 122A and 122B to the tip portions on the negative side in the x2 direction side also increases. Therefore, even if the position of the traveling device 1 in the left-right direction is largely deviated more than the error of the GPS (about ±100 mm) when the traveling device 1 enters the positioning adjusting mechanism 120E, the pair of inclined portions 323A and 323B can adjust the position and the effective range of the position adjustment in the left-right direction can be set wider than that in the above-described embodiment.

### <Application Example of Positioning Adjusting System>

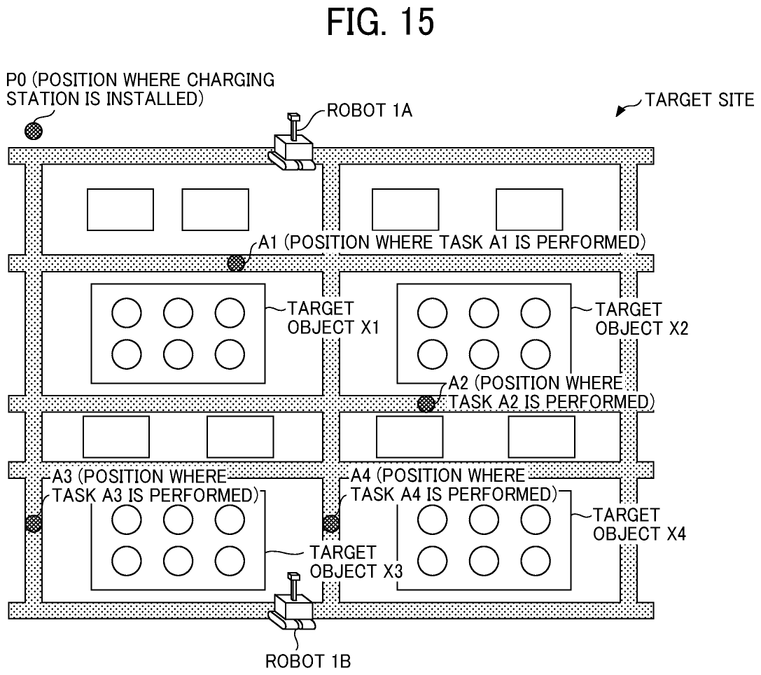

The positioning adjusting system 100 according to the embodiment is also applicable to tasks other than the charging task described above. An application example other than the charging task will be described with reference to FIG. 15.

FIG. 15 is a diagram illustrating an application example of the positioning adjusting system 100 according to the embodiment. FIG. 15 illustrates two robots 1A and 1B installed at a target site. These robots 1A and 1B each correspond to the traveling device 1 according to the above-described embodiment.

FIG. 15 illustrates an example of the target site that is an outdoor site having a large area such as a plant or a factory, for example. In the target site illustrated in FIG. 15, a plurality of target objects X1, X2, X3, and X4 are present that are to be subjected to maintenance and management such as daily inspection or periodic inspection. For example, when the target site is a plant or a factory, the target objects subjected to inspection are a measurement meter of a storage tank, a tanker for use in an operation for conveying a liquid to the storage tank, and so on.

To perform an inspection task assigned by an upper-layer system, each of the robots 1A and 1B moves autonomously within the target site and performs the inspection task at a predetermined position. Note that the robots 1A and 1B may move within the target site using technology such as line tracing or remote control from a communication terminal. In the target site, a charging station for charging the battery of each of the robots 1A and 1B is provided at a base position P0. This charging station at the base position P0 corresponds to the charging device 110 in the above-described embodiment. Thus, the positioning adjusting mechanism 120 according to the above-described embodiment is installable at the base position P0 where the robots 1A and 1B stop for charging.

In the example of FIG. 15, the robots 1A and 1B move to a base position A1 to perform the inspection task for the target object X1, and perform the inspection task for the target object X1. The robots 1A and 1B move to a base position A2 and perform the inspection task for the target object X2. The robots 1A and 1B move to a base position A3 and perform the inspection task for the target object X3. The robots 1A and 1B move to a base position A4 and perform the inspection task for the target object X4.

The positioning adjusting mechanism 120 according to the above-described embodiment is also applicable at the base positions A1, A2, A3, and A4 where the robots 1A and 1B stop to perform the inspection task. This enables the position and the attitude of the robots 1A and 1B to be kept constant at each of the base positions A1, A2, A3, and A4 each time the robots 1A and 1B perform the task multiple times, and consequently increases the reliability of the inspection task at the fixed positions.

The inspection tasks performed by the robots 1A and 1B at the base positions include, for example, tasks that are regularly performed at fixed positions and for which the positioning accuracy is desirable, such as work of measuring an air pressure, a temperature, a light intensity, a gas concentration, an odor, and the like around the robots 1A and 1B and the target objects X1, X2, X3, and X4, and work of capturing images such as moving images and still images by imaging the target objects X1, X2, X3, and X4 with an image-capturing device.

The inspection task is an example of a task to be performed by the robots 1A and 1, and the task performed by the robots 1A and 1B is not limited to the inspection work. The target site where the robots 1A and 1B are installed is not limited to a plant or a factory, and may be, for example, a business facility, a construction site, an electric power substation, or another outdoor facility. For example, if the inspection work at a site having a large area is performed by a worker (workers), it takes long to finish all the inspection work, or the inspection work may be performed by a plurality of workers in a distributed manner. In place of the workers, the robots 1A and 1B installed at the target site perform the work (tasks), which has (have) been performed by persons, to increase the work efficiency. Note that the target site is not limited to an outdoor site and may be an indoor site such as an office, a school, a factory, a warehouse, a commercial facility, or another indoor facility. The target site may be any site where the robots 1A and 1B are desired to perform the work that has been performed by persons.

The embodiment has been described above with reference to specific examples. However, the present disclosure is not limited to these specific examples. Configurations obtained by those skilled in the art making appropriate design changes to these specific examples are also within the scope of the present disclosure as long as the configurations have the features of the present disclosure. The elements provided in each of the specific examples described above and the arrangement, conditions, shapes, and the like of the elements are not limited to those illustrated but can be changed as appropriate. The combinations of the elements provided in each of the specific examples described above can be appropriately changed as long as no technical contradiction is caused.

In the above-described embodiment, the crawler-type traveling device 1 is exemplified as the traveling device that serves as the target of the positioning adjusting system 100 according to the embodiment. However, the positioning adjusting system 100 according to the embodiment is also applicable to other types of traveling devices such as an automated guided vehicle (AGV) and to a robot. In the case of the traveling device 1 that provides a speed difference between the pair of traveling bodies 10a and 10b to change the traveling direction, positioning such as fine position adjustment in the left-right direction is difficult. Thus, application of the positioning adjusting system 100 according to the embodiment is particularly effective. However, the positioning adjusting system 100 according to the embodiment is also applicable to the traveling device of another type such as a vehicle with a steering wheel.

According to a first aspect, a positioning adjusting mechanism for a traveling device includes a main body and a pair of traveling bodies that are on respective sides of the main body and are driven in contact with a surface on which the traveling device travels. The positioning adjusting mechanism further includes a first contact member that comes into contact with side portions of the pair of traveling bodies while the traveling device approaches a stop position that is predetermined, and a second contact member that comes into contact with front portions of the pair of traveling bodies in response to the traveling device reaching the stop position.

According to a second aspect, in the positioning adjusting mechanism according to the first aspect, the first contact member is disposed to abut on side portions, of the pair of traveling bodies, adjacent to the main body.

According to a third aspect, in the positioning adjusting mechanism according to the second aspect, the second contact member extends in an arrangement direction in which the pair of traveling bodies of the traveling device are arranged. The first contact member includes a pair of straight portions extending in a direction orthogonal to the extending direction of the second contact member and including base end portions coupled to the second contact member, and a pair of inclined portions coupled to respective tip end portions of the pair of straight portions and extending in a direction at a predetermined angle with respect to the extending direction of the straight portions. The pair of inclined portions are formed such that a space between the pair of inclined portions narrows as a distance from coupling portions where the pair of the inclined portions are coupled to the respective straight portions increases.

According to a fourth aspect, in the positioning adjusting mechanism according to any one of the first to third aspects, the first contact member includes a front end portion coupling tip end portions of the pair of inclined portions and extending in the arrangement direction.

According to a fifth aspect, the positioning adjusting mechanism according to any one of the first to fourth aspects further includes a third contact member that abuts on rear portions of the pair of traveling bodies in response to the traveling device reaching the stop position to adjust a position and an attitude of the traveling device in a front-rear direction.

According to a sixth aspect, the positioning adjusting mechanism according to any one of the first to fifth aspects further includes a wall located on an outer side of each of the pair of traveling bodies in a left-right direction when the traveling device is at the stop position.

According to a seventh aspect, in the positioning adjusting mechanism according to any one of the first to sixth aspects, the second contact member has a step shape toward the front portions of the pair of traveling bodies.

According to an eighth aspect, in the positioning adjusting mechanism according to any one of the first to seventh aspects, the traveling device provides a speed difference between the pair of traveling bodies to change a traveling direction.

According to a ninth aspect, in the positioning adjusting mechanism according to the eighth aspect, the pair of traveling bodies include crawler-type traveling bodies.

According to a tenth aspect, a positioning adjusting system includes the positioning adjusting mechanism according to any one of the first to ninth aspects, and a controller that controls an operation of the traveling device. The controller causes the traveling device to move to a first set position where the traveling device is separate from the first contact member and from the second contact member, faces the second contact member, and is oriented in a direction in which the traveling device is to travel straight along the first contact member, and causes the traveling device to move straight to a second set position where the pair of traveling bodies of the traveling device abut on the second contact member, so that the traveling device is positioned at the stop position.

According to an eleventh aspect, in the positioning adjusting system according to the tenth aspect, the controller detects a position of the traveling device based on a GPS signal and controls the traveling device to move to the first set position.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

As used herein, the term “connected/coupled” includes both direct connections and connections in which there are one or more intermediate connecting elements.

This patent application is based on and claims priority to Japanese Patent Application Nos. 2022-034668, filed on Mar. 7, 2022, and 2023-001295, filed on Jan. 6, 2023, in the Japan Patent Office, the entire disclosure of which is hereby incorporated by reference herein.

### REFERENCE SIGNS LIST

1 traveling device
50 main body
10, 10a, 10b crawler-type traveling body (traveling body)
540 traveling control motor driver (controller)
100 positioning adjusting system
110 charging device
120, 120A, 120B, 120C, 120D, 120E positioning adjusting mechanism
121 first guide member (first contact member)
122A, 122B straight portion
123A, 123B inclined portion
124 front end portion
125 second guide member (second contact member)
126 third guide member (third contact member)
127A, 127B wall
B point (first set position)
C chargeable position (second set position, predetermined stop position)

1: A positioning adjusting mechanism for use with a traveler, comprising:
a main body;
a pair of traveling bodies on respective sides of the main body and to be driven in contact with a surface on which the traveler travels;
a first contact to come into contact with side portions of the pair of traveling bodies while the traveler approaches a predetermined stop position (C); and
a second contact to come into contact with front portions of the pair of traveling bodies in response to the traveler reaching the stop position.

2: The positioning adjusting mechanism according to claim 1, wherein:
the first contact is disposed to abut on the side portions of the pair of traveling bodies adjacent to the main body.

3: The positioning adjusting mechanism according to claim 2, wherein:
the second contact extends in an arrangement direction in which the pair of traveling bodies of the traveler are arranged, and
the first contact includes:
a pair of straight portions extending in a direction orthogonal to an extending direction of the second contact and including base end portions coupled to the second contact, and
a pair of inclined portions coupled to respective tip end portions of the pair of straight portions and extending in a direction at a predetermined angle with respect to the extending direction of the straight portions, and
the pair of inclined portions are formed such that a space between the pair of inclined portions narrows as a distance from coupling portions where the pair of inclined portions are coupled to the respective straight portions increases.

4: The positioning adjusting mechanism according to claim 3, wherein:
the first contact includes a front end portion coupling tip end portions of the pair of inclined portions together and extending in the arrangement direction.

5: The positioning adjusting mechanism according to claim 1, further comprising:
a third contact to abut on rear portions of the pair of traveling bodies in response to the traveler reaching the stop position to adjust a position and an attitude of the traveler in a front-rear direction.

6: The positioning adjusting mechanism according to claim 1, further comprising:
a wall located on an outer side of each of the pair of traveling bodies in a left-right direction when the traveler is at the stop position.

7: The positioning adjusting mechanism according to claim 1, wherein:
the second contact has a step shape toward the front portions of the pair of traveling bodies.

8: The positioning adjusting mechanism according to claim 1, wherein:
the traveler is to provide a speed difference between the pair of traveling bodies to change a traveling direction.

9: The positioning adjusting mechanism according to claim 8, wherein:
the pair of traveling bodies include crawler-type traveling bodies.

10: A positioning adjusting system, comprising:
the positioning adjusting mechanism according to claim 1; and
control circuitry configured to control an operation of the traveler and to cause:
the traveler to move to a first set position where the traveler is separate from the first contact and from the second contact, faces the second contact, and is oriented in a direction in which the traveler is to travel straight along the first contact, and
the traveler to move straight to a second set position where the pair of traveling bodies of the traveler abut on the second contact, such that the traveler is positioned at the stop position.

11: The positioning adjusting system according to claim 10, wherein the control circuitry is further configured to:
detect a position of the traveler based on a GPS signal and control the traveler to move to the first set position.
